(19) United States
(12) Patent Application Publication
(10) Pub. No.: US 2017/0247615 A1
(43) Pub. Date: Aug. 31, 2017

(54) CHROMONIC MESOGENS FOR OPTICAL COATINGS

(71) Applicant: LIGHT POLYMERS HOLDING, George Town (KY)

(72) Inventors: Valeriy Kuzmin, San Bruno, CA (US); Elena Malozemova, San Bruno, CA (US); Evgeny Morozov, Burlingame, CA (US); Joseph Marc McConnaughey, Temecula, CA (US); Liudmila Yazykova, San Bruno, CA (US)

(21) Appl. No.: 15/440,858

(22) Filed: Feb. 23, 2017

Related U.S. Application Data
(60) Provisional application No. 62/300,378, filed on Feb. 26, 2016.

(51) Int. Cl. C09K 19/32; G02B 1/10

(52) U.S. Cl. CPC C09K 19/32; G02B 1/10

(57) ABSTRACT

Chromonic mesogens for optical coatings are disclosed. The chromonic mesogens may form a liquid crystal solution and be coated onto an optical element or substrate to form an optical coating.

This application claims the benefit of U.S. Provisional Application Ser. No. 62/300,378, filed Feb. 26, 2016, which is incorporated by reference herein.

### BACKGROUND

It is known that there are three states of matter: solids, liquid and gases. There is, however, a special fourth state of matter referred to as the liquid crystals (LCs) or mesomorphic states, intermediate between the solids and liquids. In the LC state, the material possesses long-range orientational order of the constituent units (molecules or molecular aggregates) while the long-range positional order of these units is partially or completely lost. The intermediate character of order is responsible for high sensitivity of LCs to external factors, such as the presence of electromagnetic fields or interface with another medium and also for unique optical and structural properties used in a variety of applications, ranging from computer monitors and other types of visual display systems commonly referred to as liquid crystal displays or LCDs, to materials of superior tensile strength such as Kevlar. The development of new properties and improvement of previously known properties may expand the number of applications in which liquid crystal materials may be used. One of these properties is the alignment of liquid crystal material on a substrate.

LCs may be classified as thermotropic or lyotropic. Thermotropic LCs are orientationally ordered (or mesomorphic) within a specific temperature range. In contrast, lyotropic LC materials become mesomorphic when dissolved in a solvent (such as water) within an appropriate concentration range. The LC state occurs within an appropriate range of parameters such as temperature and concentration.

Lyotropic LCs may be amphiphilic materials (surfactants) formed by molecules that have a polar (hydrophilic) fragment and a non-polar (hydrophobic) fragment. This dual character of the molecules leads to self-organization, for example, micelle formation, when they are dissolved in a solvent such as water or oil.

### SUMMARY

The present disclosure relates to chromonic molecules or mesogens for optical coatings. The chromonic molecules or mesogens may be utilized alone, or be combined with other chromonic molecules or mesogens and/or coating materials, and coated onto an optical element or substrate to form an optical coating.

In one aspect, a composition includes, a chromonic molecule represented by a structure:

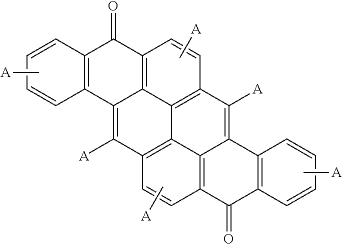

wherein each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺.

In another aspect, a composition includes, a chromonic molecule represented by a structure:

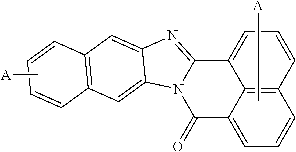

wherein each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺.

In a further aspect, a composition includes, a chromonic molecule represented by a structure:

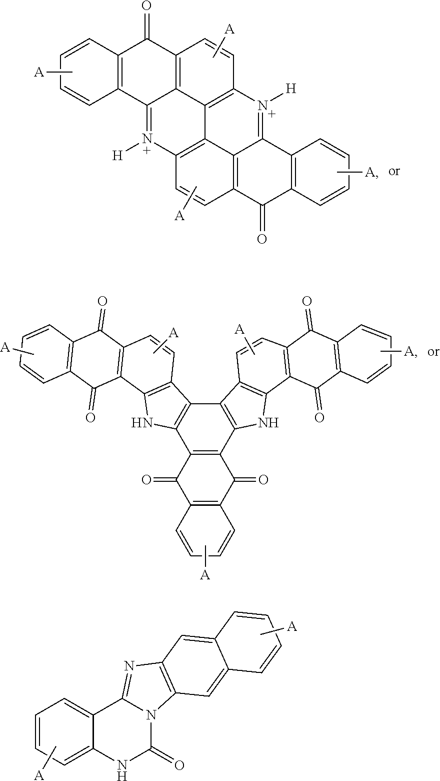

wherein each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺.

These and various other features and advantages will be apparent from a reading of the following detailed description.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising,” and the like.

In this disclosure:

“visible light” refers to light wavelengths generally from about 400 nm to about 800 nm;

“achromatic” refers to color-less;

“alkyl” “alkenyl” and “alkenyl” are linear or branched carbon chains having from one to a specified number of carbon atoms and having single bonds, at least one double bond and at least one triple bond, respectively;

“alkoxy” is an ether substituent group that includes linear or branched carbon chain having from one to a specified number of carbon atoms; and

“molecule” refers to a single compound structure or a salt or complex and also refers to a plurality of structures that may be isomers or derivatives of the core structure of each molecule illustrated herein.

The present disclosure relates to chromonic molecules or mesogens for optical coatings. The chromonic molecules or mesogens may be coated onto an optical element or substrate to form an optical coating. Chromonic mesogens form a liquid crystal phase in a solvent, such as water for example, to form a lytrotropic liquid crystal material solution. The lyotropic liquid crystal material solution may be coated onto a substrate or optical element to form an optical coating that may alter spectral or polarization of light incident on the optical coating. The lyotropic liquid crystal material solution can be shear coated onto the substrate or optical element to produce a shear induced alignment or orientational order of the molecules in the coated lyotropic liquid crystal material solution. Once the optical coating is dried, the alignment or orientational order of the molecules in the optical coating is preserved to create anisotropic optical properties of the optical coating. This optical coating may have a thickness of less than five micrometers, or less than two micrometers, or less than one micrometer, or in a range from 500 nanometers to 1000 nanometers, or in a range from 500 nanometers to 750 nanometers. The optical coating may be converted to a water-insoluble layer by ion exchange of mono-valent ions with poly-valent ions. The optical coating can be coated directly onto an optical element such as a glass substrate of a LCD panel or on a polymeric substrate or element of a display device. The optical element may be a planar surface or a curved surface. While the present disclosure is not so limited, an appreciation of various aspects of the disclosure will be gained through a discussion of the examples provided below.

In this disclosure the anisotropic structure of liquid crystal molecules is utilized. These liquid crystal molecules are chromonic mesogens that are soluble in a solvent such as water or an organic solvent. An aligned optical coating layer is obtained by shear coating these lyotropic liquid crystal solutions. These chromonic mesogens can be combined with other chromonic mesogens or molecules, polymers or small molecules to form the optical coating layer. Preferably, water soluble chromonic mesogens are utilized to form a lyotropoic liquid crystal phase.

Shear coating methods include slot coating, slit coating, doctor blade coating, die coating, slot-die coating, gravure coating, micro-gravure coating, curtain coating and the like. After the shear coating step, the coated solution is dried to remove the solvent and form an aligned optical coating or layer of an aligned chromonic material. Once coated or deposited the aligned chromonic material may be stabilized or made less solvent-soluble by cross-linking or by ion exchange, generally termed “passivation.” This may also be referred to as “converting” the aligned material layer to a water insoluble aligned material layer. This passivation or converting step may be performed by treating or contacting the aligned chromonic material with a multivalent metal salt material or solution.

The optical coating may be coated directly onto a substrate or an optical element. The substrate or an optical element may be primed and/or corona treated to improve adhesion of the optical coating to the surface of the substrate or an optical element. The optical coating may be coated to have the aligned chromonic material align parallel with the edges of the substrate or an optical element (e.g., along the coating or machine direction). In other embodiments, the optical coating may be coated to have the aligned chromonic material align at an acute angle with the edges of the substrate or an optical element.

The final optical coating layer has any useful thickness. The optical coating may have a thickness of less than 10 micrometers, or less than 5 micrometers, or less than 3 micrometers, or less than 2 micrometers, or less than 1 micrometer, or less than 750 nm. The optical coating may have a thickness in a range from 250 nanometers to 5 micrometers, or from 500 nanometers to 2 micrometers, or from 500 nanometers to 1 micrometer, or from 500 nanometers to 1000 nanometers, or from 500 nanometers to 750 nanometers.

The optical coating can be utilized to alter or modify spectral or polarization properties of light incident on the optical coating. In many embodiments, the optical coating transmits visible light. The optical coating may be achromatic. The optical coating may be formed of a mixture of chromic molecules or mesogens, such as two or more chromic mesogens, or three or more chromic mesogens, where each chromic mesogens has a different structure. Each chromic mesogens may have a different visible light absorption or transmission spectrum. A variety of different chromic mesogens may form a mixture that results in an achromatic optical coating (for example, an achromatic polarizer layer).

The substrate may be glass or a polymeric layer such as a polyolefin (PET or PEN), polycarbonate, or polyimide and the like. Glass substrates may form an element of a liquid crystal display panel. The glass substrate may have a reduced thickness such as a 1000 micrometers or less or 500 micrometers or less. In embodiments where the substrate is a polymer layer, the polymeric layer may be a flexible film layer that may be processed in a roll-to-roll manufacturing process.

A composition may include a chromonic molecule represented by a structure:

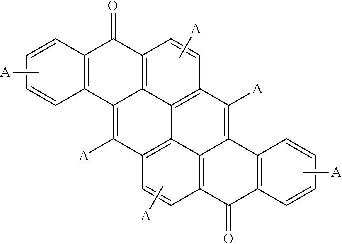

wherein each A is independently, H, Cl or SO₃M, and M is H, alkali metal or ammonia or a substituent group that renders the chromonic mesogen soluble in an organic solvent, and at least one A is SO₃M or a substituent group that renders the chromonic mesogen soluble in an organic solvent.

Preferably, each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺. Preferable poly-valent ions include Sr²⁺, Al³⁺, or La³⁺.

This chromonic mesogen can be formed, for example, by the following reaction scheme.

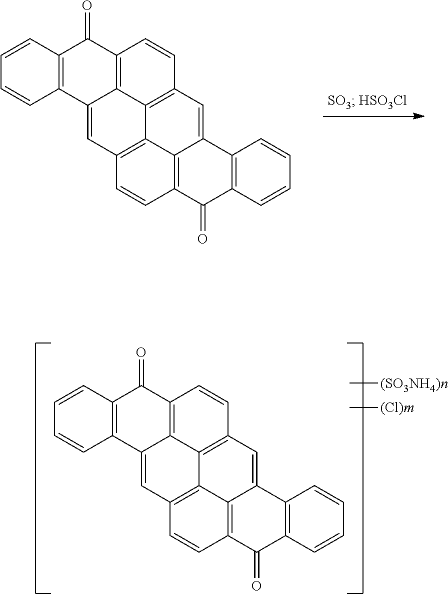

m=1-2, n=2-4

15 g of Vat Orange 9 pigment (commercially available) was mixed with 30 ml chlorosulfonic acid and 60 ml 20% Oleum. The reaction mass was heated to 100 degrees C. and kept at temperature for 16 hours. Then it was quenched with 65 ml of 91% sulfuric acid and 210 ml of water and filtered. The filter cake was dissolved in 3 L of water, neutralized with 25% ammonium hydroxide and ultrafiltered using PES5 membrane. Yield 500 ml of 3.1% solution.

A composition may include a chromonic mesogen represented by a structure:

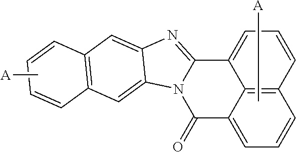

wherein each A is independently, H or SO₃M or COOM and M is H, alkali metal or ammonia or a substituent group that renders the chromonic mesogen soluble in an organic solvent, and at least one A is SO₃M or COOM or a substituent group that renders the chromonic mesogen soluble in an organic solvent. The naphthyl group may have 1 or 2 “A” substituents bonded thereto.

Preferably, each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺. Preferable poly-valent ions include Sr²⁺, Al³⁺, or La³⁺.

This chromonic mesogen can be formed, for example, by the following reaction scheme.

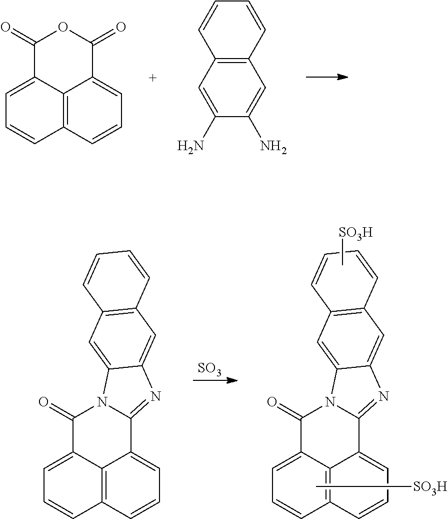

1.0 g 1,8-Diamininaphthalene and 1.19 g 1,8-naphthalic anhydride was heated in 15 ml glacial acetic acid at 115 degrees for 5 hours. Then the reaction mass was cooled, filtered and the filter cake washed on filter with 20 ml of glacial acetic acid. Yield of Naphthaleneimidazole compound was 1.6 g.

1 g of the Napthaleneimidazole compound was added to 6 ml of 20% Oleum, heated with agitation to 100-105 degrees C. and kept at temperature for 16 hours. Then the reaction mass was quenched with 3.5 ml of 95% sulfuric acid and 17 ml of water and filtered. The filter cake was dissolved in 200 ml of water and ultrafiltered using Amicon filtration cell with NF245 membrane. Yield was 50 ml of 2.5% solution.

A composition may include a chromonic molecule represented by a structure:

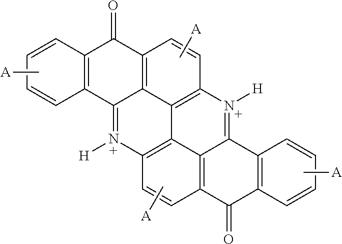

wherein A may be independently, H, Cl or SO₃M, and M is H, alkali metal or ammonia. At least one of A is not hydrogen. At least one of A is a sulfonic group or a carboylic group or their salt. In other embodiments, A is independently selected from the list consisting of linear and branched (C₁-C₂₀)alkyl, (C₂-C₂₀)alkenyl, and (C₂-C₂₀)alkinyl. Additionally this substituent group may be connected with the core molecule via bridging groups selected from the list consisting of —C(O)—, —C(O)O—, —C(O)—NH—, —(SO₂)NH—, -Phenylene-, —O— Phenylene-, —CH₂O—, —NH—, >N—, and any combination thereof.

Alternatively, each A is independently, H or SO₃M or COOM and M is H, alkali metal or ammonia or a substituent group that renders the chromonic mesogen soluble in an organic solvent, and at least one A is SO₃M or COOM or a substituent group that renders the chromonic mesogen soluble in an organic solvent.

Preferably, each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺. Preferable poly-valent ions include Sr²⁺, Al³⁺, or La³⁺.

This chromonic mesogen can be formed, for example, by the following reaction scheme.

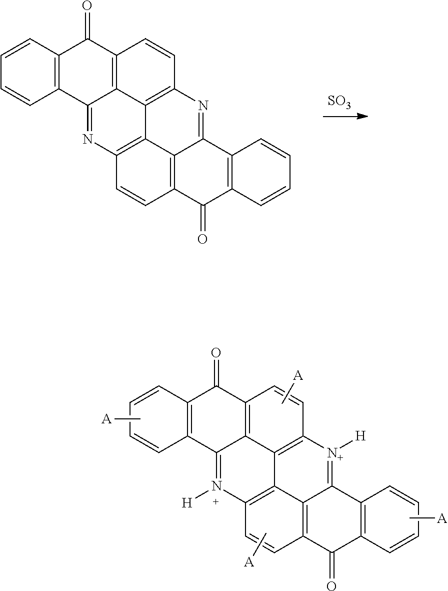

where A=H, SO3- or SO₃H. This can be referred to as a mixture of sulfonic acids of Flavanthrone. Flavanthrone is commercially available from TCI America or Sigma-Aldrich. The protonated nitrogen atoms may change the absorption spectrum to a neutral color or colorless or achromatic.

To form this mixture of sulfonic acids of Flavanthrone: 1.0 g of ground Flavanthrone and 6 ml of 20% Oleum were mixed in a 15-ml round bottom flask, heated to 100 degrees C. and held at temperature for 22 hours. Then the reaction mass was cooled, quenched with 8 ml of water and filtered through a glass fiber filter. The filter cake was washed with 100 ml of glacial acetic acid and then with 60 ml of acetone and dried to yield 0.78 g of the product.

A composition may include a chromonic molecule represented by a structure:

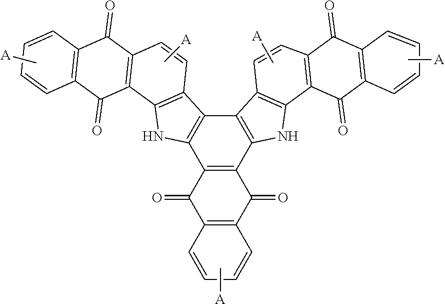

wherein each A is independently, H, Cl, COOM or SO₃M, and M is H, alkali metal or ammonia. At least one of A is not hydrogen. At least one of A is COOM or SO₃M. In other embodiments, A is independently selected from the list consisting of linear and branched (C₁-C₂₀)alkyl, (C₂-C₂₀)alkenyl, and (C₂-C₂₀)alkinyl. Additionally this substituent group may be connected with the core molecule via bridging groups selected from the list consisting of —C(O)—, —C(O)O—, —C(O)—NH—, —(SO₂)NH—, -Phenylene-, —O-Phenylene-, —CH₂O—, —NH—, >N—, and any combination thereof.

Alternatively, each A is independently, H or SO₃M or COOM and M is H, alkali metal or ammonia or a substituent group that renders the chromonic mesogen soluble in an organic solvent, and at least one A is SO₃M or COOM or a substituent group that renders the chromonic mesogen soluble in an organic solvent.

Preferably, each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺. Preferable poly-valent ions include Sr²⁺, Al³⁺, or La³⁺.

This chromonic mesogen can be formed, for example, by the following reaction scheme.

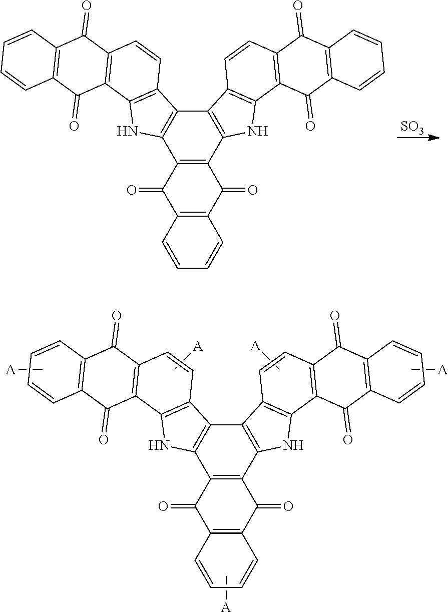

where A=H, Cl or SO₃M, where M=H, alkali metal, ammonia. This can be referred to as a mixture of sulfonic acids or their salts of chloro-derivatives of Vat Brown 1 (6,23-dihydrodinaphtho[2,3-a:2′,3′-i]naphtho[2′,3′:6,7]indolo[2,3-c]carbazole-5,7,12,17,22,24-hexone) and commercially available from Haohua Industry Co. Ltd. (China).

To form this mixture of Vat Brown 1 acids or salts: 2.0 g of ground Vat Brown 1 pigment was mixed with 2 ml of chlorosulfonic acid and 4 ml of 20% Oleum in a 25-ml round bottom flask, heated to 100 degrees C. and held at temperature for 22 hours. The reaction mass was allowed to cool to room temperature and quenched with 4 ml of 91% sulfuric acid and then with 13 ml of water. The precipitated material was isolated by filtration on a glass fiber filter and the filter cake was washed with 180 ml of glacial acetic acid and then with 80 ml of acetone and dried. Yield of the dry product was 2.3 g.

A composition may include a chromonic molecule represented by a structure:

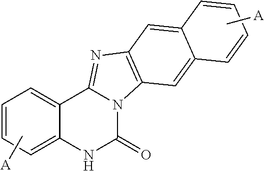

wherein n is 0, 1, or 2 and m is 0, 1 or 2. At least one of n or m is at least 1 and A is independently, H, COOM or SO₃M, and M is H, alkali metal or ammonia. At least one of A is not hydrogen. At least one of A is COOM or SO₃M. In other embodiments, A is independently selected from the list consisting of linear and branched (C₁-C₂₀)alkyl, (C₂-C₂₀)alkenyl, and (C₂-C₂₀)alkinyl. Additionally this substituent group may be connected with the core molecule via bridging groups selected from the list consisting of —C(O)—, —C(O)O—, —C(O)—NH—, —(SO₂)NH—, -Phenylene-, —O-Phenylene-, —CH₂O—, —NH—, >N—, and any combination thereof.

Alternatively, each A is independently, H or SO₃M or COOM and M is H, alkali metal or ammonia or a substituent group that renders the chromonic mesogen soluble in an organic solvent, and at least one A is SO₃M or COOM or a substituent group that renders the chromonic mesogen soluble in an organic solvent.

Preferably, each A is independently, H or SO₃H or SO₃⁻ or COOH or COO⁻, or a salt thereof, and at least one A is SO₃H or SO₃⁻ or COOH or COO⁻, or a salt thereof.

The chromonic molecule may be a chromonic mesogen, where at least one A is SO₃M or COOM, and M is H or Na⁺, K⁺, Cs⁺, or NH⁴⁺. This chromonic mesogen may be combined with a solvent, such as water, to form a lyotropic liquid crystal solution. The lyotropic liquid crystal solution may be formed of a mixture of two or more different chromonic mesogens where each of the two or more different chromonic mesogens have a structure that is different from each other. The lyotropic liquid crystal solution can be coated or shear coated onto a substrate to form an optical coating having a thickness in a range from 500 nanometers to 2 micrometers, or from 500 nanometers to 1 micrometer, or from 500 nanometers to 750 nanometers. The optical coating may be disposed or formed on an optical substrate.

A method of forming the optical coating may include shear coating the lyotropic liquid crystal solution onto the substrate to form an aligned liquid crystal layer and then drying the aligned liquid crystal layer to form a layer of aligned material layer. The aligned material layer may be stabilized by converting the aligned material layer to a water insoluble aligned material layer. The water soluble or water insoluble aligned material layer may have a thickness in a range from 500 nanometers to 2 micrometers, or from 500 nanometers to 1 micrometer, or from 500 nanometers to 750 nanometers.

This conversion may be accomplished by ion exchange of non-valent ions with poly-valent ions. The water insoluble aligned material layer includes the chromonic molecule described above wherein at least one, or at least two, or at least three “A” is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺. Preferable poly-valent ions include Sr²⁺, Al³⁺, or La³⁺.

This chromonic mesogen can be formed, by example, by the following reaction scheme.

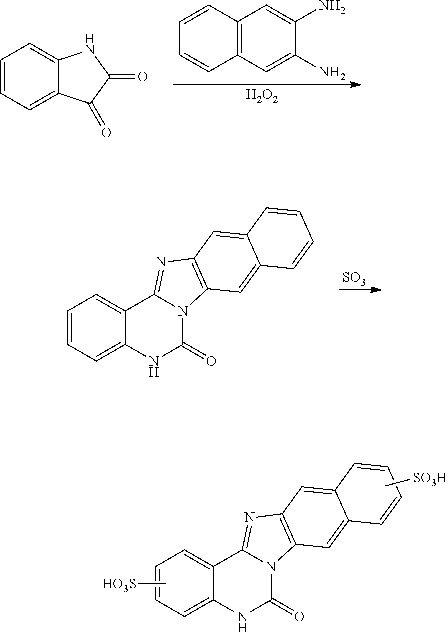

This can be referred to as a mixture of sulfonic acids or their salts of Naphtho[2′,3′:4,5]imidazo[1,2-c]quinozalin-6(5H)-one.

To form this mixture: 1.88 g of Isatin was added to a mixture of 19 ml of 37% HCl and 10 ml of water. In a separate container a mixture of 1 ml of 37% HCl, 42 ml of water and 2.0 g of 2,3-diaminonaphthalene was prepared. The mixtures were combined, 1.2 g of 30% hydrogen peroxide was added and the resulting reaction mass was heated to 55 degrees C. and kept at temperature for 1 hour. The product of the condensation was isolated by filtration and washed with 40% acetic acid. Finally the product was dried at 90 C. Yield was 2.4 g.

1.0 g of the dry product of condensation was mixed with 5 ml of 20% Oleum and agitated at room temperature for 22 hours. The reaction mass was quenched with 6 ml of 96% sulfuric acid and 11 ml of water. The precipitated solid was isolated by filtration, washed with 50 ml of glacial acetic acid then with 50 ml of Acetione and dried. Yield was 0.35 g.

All chemical materials listed herein (and not specifically mentioned by source) are commercially available from Sigma-Aldrich (USA).

The composition may preferably form a lyotropic liquid crystal solution of a solvent, such as water and one or more of the chromonic mesogen described above. This lyotropic liquid crystal solution can be coated to from an optical coating. The optical coating may be disposed or formed on an optical substrate.

The lyotropic liquid crystal solution may have any useful chromonic mesogen concentration. The lyotropic liquid crystal solution may have a chromonic mesogen concentration in a range from about 1 to 40% wt based on the total weight of the lyotropic liquid crystal solution. The lyotropic liquid crystal solution may have a chromonic mesogen concentration in a range from about 3 to 30% wt based on the total weight of the lyotropic liquid crystal solution.

The lyotropic liquid crystal solution may form a homogeneous liquid crystal phase and include a mixture of two chromonic mesogens that each have a different structure. The lyotropic liquid crystal solution may form a homogeneous liquid crystal phase and include a mixture of three chromonic mesogens that each have a different structure. The lyotropic liquid crystal solution may form a homogeneous liquid crystal phase and include a mixture of four chromonic mesogens that each have a different structure. At least one of the chromonic mesogens in the mixture is selected from any of the chromonic mesogens described herein.

An optical coating can be formed from any of these lyotropic liquid crystal solutions by coating the lyotropic liquid crystal solution onto a substrate or optical element. The lyotropic liquid crystal solution can be shear coated to form an aligned liquid crystal layer. Then the aligned liquid crystal layer can be dried to form a layer of aligned material layer. The aligned material layer may be described as an anisotropic material layer.

Conventional alignment techniques may also be utilized such as rubbed polymer films, surface structured substrates or photoalignment. The lyotropic liquid crystal solution may be coated onto the substrate and aligned according to any of the above techniques.

A method of forming the optical coating may include shear coating the lyotropic liquid crystal solution onto the substrate to form an aligned liquid crystal layer and then drying the aligned liquid crystal layer to form a layer of aligned material layer. The aligned material layer can be stabilized by converting the aligned material layer to a water insoluble aligned material layer.

Thus, embodiments of CHROMONIC MESOGENS FOR OPTICAL COATING are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

What is claimed is:

1. A composition comprising, a chromonic molecule represented by a structure: 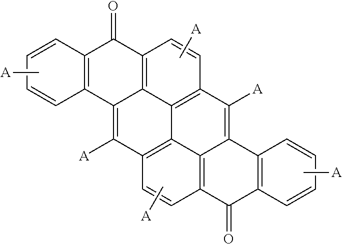
wherein each A is independently, H or SO₃H or SO₃⁻ or COOH or COO⁻, or a salt thereof, and at least one A is SO₃H or SO₃⁻ or COOH or COO⁻, or a salt thereof.

2. A composition according to claim 1, wherein the molecule is a chromonic mesogen, and at least one A is SO₃M or COOM, and M is H or Na⁺, K⁺, Cs⁺, or NH⁴⁺.

3. A composition according to claim 1, wherein the composition comprises two or more different chromonic molecules and each of the two or more different chromonic molecules have a structure that is different from each other.

4. A lyotropic liquid crystal solution comprising an aqueous solvent and a chromonic mesogen of claim 2.

5. An optical coating comprising a composition according to claim 1, the optical coating having a thickness in a range from 500 nanometers to 2 micrometers.

6. An optical article comprising:
an optical substrate; and
the optical coating according to claim 5 disposed on the optical substrate, wherein at least one A is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺.

7. A method comprising:
shear coating a lyotropic liquid crystal solution of claim 4 onto a substrate to form an aligned liquid crystal layer;
drying the aligned liquid crystal layer to form a layer of aligned material layer having a thickness in a range from 500 nanometers to 1 micrometer.

8. The method according to claim 7, further comprising converting the aligned material layer to a water insoluble aligned material layer with ion exchange of mono-valent ions with poly-valent ions.

9. A composition comprising, a chromonic molecule represented by a structure: 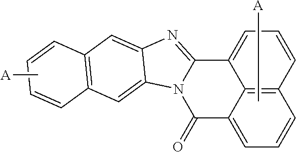
wherein each A is independently, H or SO₃H or SO₃⁻ or COOH or COO⁻, or a salt thereof, and at least one A is SO₃H or SO₃⁻ or COOH or COO⁻, or a salt thereof.

10. A composition according to claim 9, wherein the chromonic molecule is a chromonic mesogen, and at least one A is SO₃M or COOM, and M is H or Na⁺, K⁺, Cs⁺, or NH⁴⁺.

11. A composition according to claim 9, wherein the composition comprises two or more different chromonic molecules and each of the two or more different chromonic molecules have a structure that is different from each other.

12. A lyotropic liquid crystal solution comprising an aqueous solvent and a chromonic mesogen of claim 10.

13. An optical coating comprising a composition according to claim 9, the optical coating having a thickness in a range from 500 nanometers to 2 micrometers.

14. An optical coating comprising a composition according to claim 10.

15. An optical article comprising:
an optical substrate; and
the optical coating according to claim 13 disposed on the optical substrate, wherein at least one A is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn²⁺.

16. A method comprising:
shear coating a lyotropic liquid crystal solution of claim 12 onto a substrate to form an aligned liquid crystal layer;
drying the aligned liquid crystal layer to form a layer of aligned material layer having a thickness in a range from 500 nanometers to 1 micrometer.

17. The method according to claim 16, further comprising converting the aligned material layer to a water insoluble aligned material layer with ion exchange of mono-valent ions with poly-valent ions.

18. A composition comprising, a chromonic molecule represented by a structure: 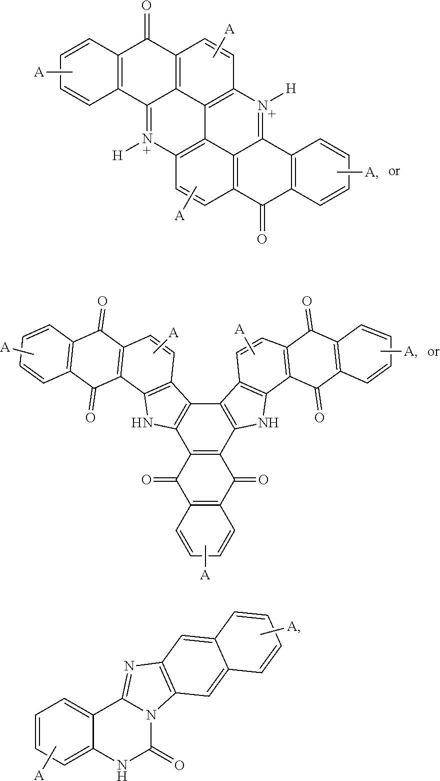
wherein each A is independently, H or SO₃H or SO₃⁻ or COOH or COO⁻, or a salt thereof, and at least one A is SO₃H or SO₃⁻ or COOH or COO⁻, or a salt thereof.

19. A composition according to claim 18, wherein the chromonic molecule is a chromonic mesogen, and at least one A is SO₃M or COOM, and M is H or Na⁺, K⁺, Cs⁺, or NH⁴⁺, and the composition comprises two or more different chromonic mesogens and each of the two or more different chromonic mesogens have a structure that is different from each other.

20. An optical article comprising:
an optical substrate; and
an optical coating comprising a composition according to claim 18, the optical coating having a thickness in a range from 500 nanometers to 2 micrometers;
the optical disposed on the optical substrate, wherein at least one A is SO₃M or COOM and M is Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Cr²⁺, or Sn^{2+.}
